(19) United States
(12) Patent Application Publication
(10) Pub. No.: US 2008/0256225 A1
(43) Pub. Date: Oct. 16, 2008

(54) Osgi-Based Dynamic Service Management Method for Context-Aware Systems

(76) Inventors: Youngho Suh, Gwangju (KR); Hyun Kim, Daejon (KR); Kang Woo Lee, Daejon (KR); In Cheol Jeong, Daejon (KR)

Correspondence Address: LADAS & PARRY LLP, 224 SOUTH MICHIGAN AVENUE, SUITE 1600, CHICAGO, IL, 60604, US

(21) Appl. No.: 12/088,124

(22) PCT Filed: Dec. 15, 2005
(86) PCT No.: PCT/KR2005/004324

§ 371 Date: Mar. 26, 2008

(30) Foreign Application Priority Data
Dec. 8, 2005 (KR) 10-2005-0119720

(51) Int. Cl. G06F 19/00

(52) U.S. Cl. 709/223

(57) ABSTRACT

An OSGi-based dynamic service management method for context-aware system is provided. By adding a service bundle for service implementation to an OSGi framework, a service lifecycle is separately managed. For this purpose, the service bundle has several service implementations, and a service factory object is generated as many as the service implementations. The lifecycle of the service is managed. The service factory object installs and uninstalls the service. Accordingly, even when various sensors and devices are newly added to the context-aware system, a corresponding service can be installed and uninstalled at any time, thereby providing a dynamic management.

### TECHNICAL FIELD

The present invention relates to a service management method based on an expanded OSGi-based service framework, and more particularly, to an OSGi-based dynamic service management method for context-aware system, which is used as a tool of modeling physical spaces of the context-aware system into a virtual space environment.

### BACKGROUND ART

Environment in a context-aware system is an abstraction of a real world and models physical objects, such as sensors and devices of the real world, into resources of the environment. A user can access the physical objects of the real world through the environment mapped (modeled) on a virtual space. For example, if there are sensors and devices that can provide a network communication in the real world, the sensors and the devices can exist in a form of a sensor object and a device object in the environment expressed in the virtual space. Information acquired by the sensor in the real world can be transferred as a sensor object of the environment. Also, by changing a power value to “ON” among the attributes of a corresponding device object through the service provided from the environment, a device of the real world can be powered on. That is, the service is a computer program module that can execute the physical functions of the sensors or devices of the environment on the virtual space. Accordingly, there is a demand for a technology that dynamically manages the corresponding service so that the sensors and devices existing in the real world can be easily modeled and controlled in the environment of the virtual space.

Like this, the service in the context-aware system means a proxy object that can control these devices under the environment given by mapping the sensors and devices of the physical space into the virtual space. The various sensors and devices of the physical space can be moved or removed and can also be modeled differently depending on application domains. Therefore, the service must be able to be dynamically managed depending on various environment variations.

The related technology is disclosed in a patent entitled “Emergency messaging service using home server built in OSGi service platform and method thereof”, issued in 2004. In this patented invention, however, the OSGi service has the same lifecycle as an installed bundle. That is, at a time point when one bundle starts, the corresponding bundle generates service instants and registers them as a framework service. At a time point when the bundle is terminated, the framework automatically cancels the registration of all registered services. This fact means that the lifecycle of a service level cannot be separately managed in the OSGi framework. In other words, once one bundle starts, the service instant cannot be additionally generated. Likewise, before the bundle itself is terminated, any service cannot be stopped.

Therefore, there is a demand for a service management technology that can dynamically install and uninstall the sensors and devices for modeling various physical spaces into virtual space environment.

Meanwhile, the OSGi service framework provides an execution environment that can install, update, and uninstall the bundles, which are Java-based application services. In the respective bundles, collaboration is possible by providing “service” (application component) to other bundles. In the OSGi service framework, if one bundle is installed, all services in an inside of the bundle are registered in a service registry so that other bundles can use them. Therefore, since the services in an inside of the existing OSGi framework share lifecycle of bundles where the services are contained, the management based on service unit is difficult. That is, when the bundle is activated, the service instant is generated and registered in the service registry within the framework. When the bundle is terminated, they are automatically uninstalled from the registry. In the context-aware system, however, the service must be able to be generated and terminated even while the bundle is in the activated state. The reason for this is that the real environment may be changed even after the bundle is installed. For example, other devices of the same kind may be added.

Therefore, there is a demand for a dynamic service management method that can dynamically manage the service by expanding the OSGi framework.

### DISCLOSURE OF INVENTION

### Technical Problem

To solve the above-described problems of the related art, the present invention provides an OSGi-based dynamic service management method for context-aware system, in which an ID is assigned through a specific service parameter with respect to service implementation within one activated bundle, and a new service is generated, such that a service lifecycle is separately managed. Also, the services can be separately terminated without terminating the bundle.

### Technical Solution

The present invention provides an OSGi-based dynamic service management method for context-aware system. In the OSGi-based dynamic service management method, sensors and devices of a variable physical space can be easily modeled into a virtual space environment, and a home server with an OSGi service platform that can distribute/manage a service bundle at a remote location. A service bundle is downloaded to the home server in a service provider side according to a user's request, and the OSGi service platform can be managed and updated. Due to the use of the OSGi service platform that can be managed at a remote location, it is easy to maintain and upgrade the system. Also, the bundle installed in the OSGi service platform can be uninstalled at a remote location.

### ADVANTAGEOUS EFFECTS

According to the present invention, the OSGi-based dynamic service management method for the context-aware system according to the present invention can obtain the following effects.

First, if necessary, the corresponding service can be installed even when various sensors and devices are newly added in the context-aware system.

Second, since the user can model the environment at a remote location, it is possible to apply the context-aware with respect to various environments.

Third, the services for the sensors and devices can be installed in the virtual space from a remote location without visiting the respective physical spaces, even when the environment is changed. Therefore, the user can easily model various environments, such as office and room.

### BRIEF DESCRIPTION OF THE DRAWINGS

FIG. 1 is a conceptual diagram of a context-aware system for explaining a method of the present invention.

FIG. 2 is a diagram of an OSGi framework for explaining an OSGi-based dynamic service management method according to the present invention.

FIG. 3 is a diagram illustrating elements of a service manager according to the present invention.

FIG. 4 is a diagram of a service descriptor for the dynamic service method according to the present invention.

FIG. 5A to 5D are diagrams illustrating procedures of the service manager for the dynamic service method according to the present invention.

### BEST MODE FOR CARRYING OUT THE INVENTION

The present invention provides an OSGi-based dynamic service management method for context-aware system, which can dynamically manage service by expanding an OSGi framework. That is, service bundle for service implementation is added to the OSGi framework and thus the service lifecycle can be separately managed. For this purpose, the added components include a service bundle for service implementation in the OSGi framework, a bundle activator for registering the bundle, a service installer for managing the service bundle, a service bundle info that is a service bundle information, and a service factory given by mapping the service bundle.

At this point, the service bundle includes several service implementations, and the service factory object is generated as many as the service implementations and manages the lifecycle of the service. The service factory object provides a function for generating and uninstalling the service. Also, the dynamic service manager of the present invention performs the following operations. That is, the dynamic service manager registers the implementation from a repository to an OSGi service framework through the activator. The service installer generates and installs the service bundle object. The service installer updates a new versions of bundle. The service installer uninstalls the bundle stored in a cache. The service is generated and uninstalled through the service factory object.

By providing the dynamic service management method, the dynamic management is possible such that a corresponding service can be installed in some cases and uninstalled at any time, even when various sensors and devices are newly added in the context-aware system. Consequently, an object of the present invention is to manage the service for sensors and devices at a remote location. Even when the environment changes, the service for the sensors and devices can be installed in a virtual space at a remote location without visiting respective physical spaces. Therefore, the user can easily model various environments, such as office and room.

Hereinafter, the OSGi-based dynamic service management method for context-aware system will be described in detail with reference to the accompanying drawings.

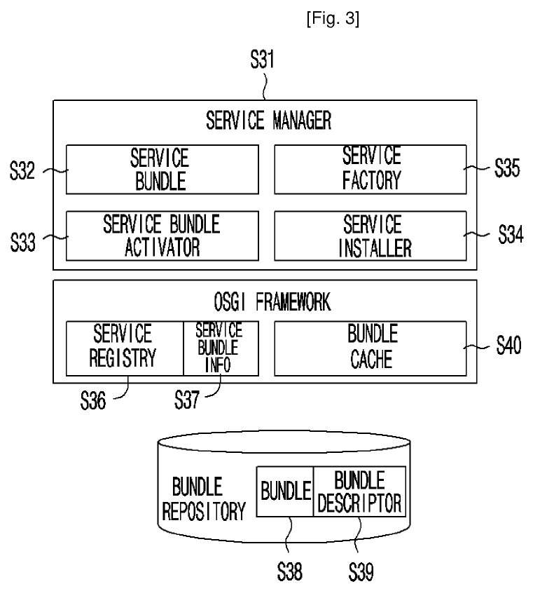

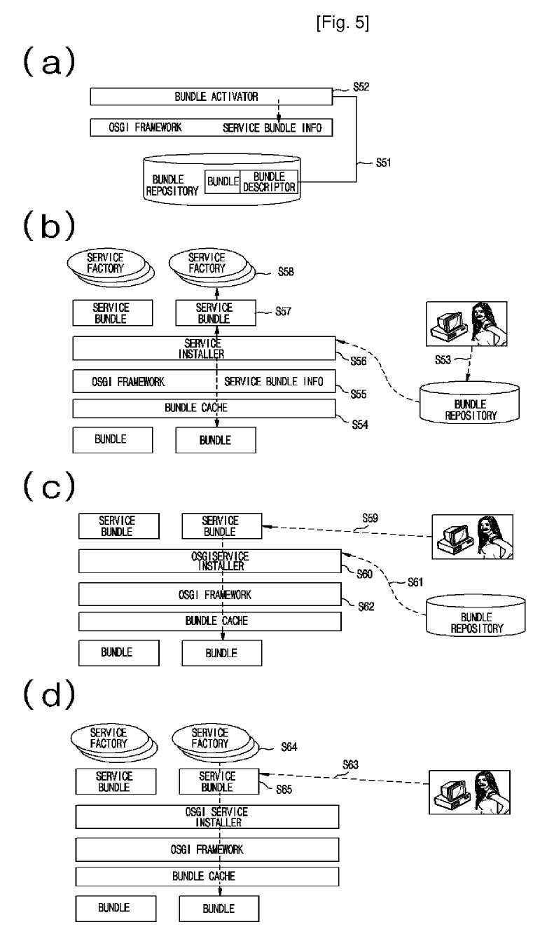

First, the present invention provides a dynamic service management method that can dynamically manage the service by expanding the OSGi framework. For this purpose, the present invention provides a service manager in which five components are further added to the OSGi service framework. That is, a service bundle, a bundle activator, a service installer, a service bundle info, a service factory are added to the OSGi service framework. FIG. 3 is a diagram illustrating a structure of the service manager according to the present invention, and FIG. 5 is a diagram illustrating operating procedures of the added object. In the present invention, the sensors or devices within the environment are defined as service. First, the conceptual structure of the context-aware system will first described with reference to FIG. 2 for fully understanding the present invention, and the dynamic service management method will be then described in detail.

Conceptual Structure of System

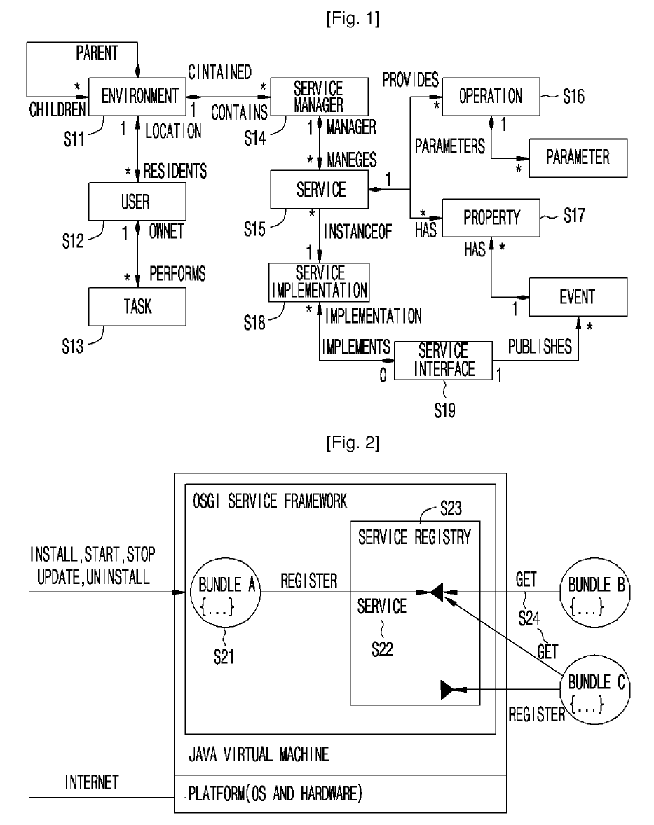

FIG. 1 is a conceptual diagram of the context-aware system.

An environment S11 is given by abstracting a limited space. The environment S11 can communicate with a computer and includes various sensors and devices having identifiers. In the real space, the environment has an identifier and a hierarchy structure expressed as parents and children. The environment is a place, such as room and kitchen in apartment, classroom and staff room in school, where the users S12 perform real tasks S13. Also, the environment is unit of user's movement. For example, the user can perform a conference related task in the conference room. Each environment has zero or more than one service manager S14. Although there is no service, the service manager S14 generally manages one or more services S15. The service S15 is a computer program module that can execute the physical functions of the sensors or devices of the environment in a virtual space and has a form of a proxy object with several available sensors and devices. The service includes an operation S16 and a property S17. The operation S16 can be variously executed by inputted parameters. For example, in a “turn on light” service, a brightness can be variously controlled by assigning a parameter of “intensity”. Various service types are set by defining a service interface S19. The service interface S19 can be implemented by more than one service implementation S19.

OSGi Service Framework

FIG. 2 is a diagram of the OSGi service framework. The OSGi service framework provides an execution environment that can install, update, and uninstall the bundle so as to use the bundle S21, which is a Java-based application service. In the respective bundles, collaboration can be possible by providing “service” S22 (application component) to other bundles. The OSGi service is one application component that the bundle existing in a local OSGi framework shares. In the OSGi framework, all services have the same lifecycle as the bundles belonging thereto. That is, at a time point when one bundle starts, the corresponding bundle generates service instants, and all services inside the bundle are registered in a service registry S23. When the bundle is terminated, the framework automatically cancels the registration of all the services that have been already registered. The registration in the service registry is an operation of notifying available services to another bundle. If the service provided by the bundle A is required, the bundle B can get a corresponding service through the registry (S24).

Service Manager for Dynamic Service Management with Expanded OSGi Framework

Since the services in the existing OSGi framework share the lifecycle of the bundle where the services are contained, the management based on service unit is difficult. That is, when the bundle is activated, the service instant is generated and registered in the service registry inside the framework. When the bundle is terminated, it is automatically uninstalled from the registry. In the context-aware system, however, the service must be able to be generated and terminated even while the bundle is in the activated state. The reason for this is that the real environment may be changed even after the bundles are installed. For example, other devices of the same kind may be added.

In this viewpoint, the service manager S31 for the dynamic service according to the present invention includes a service bundle S32, a service bundle activator S33, a service installer S34, and a service factory S35. These objects are implemented as a remote object such that they can be remotely managed, thereby providing a remote access. A service bundle info S37 is added to the service registry S36 within the OSGi framework. FIG. 3 is a diagram of the service manager for the dynamic service management with expanded OSGi framework.

The service bundle S31 has a bundle with service implementation. The bundle S38 means a program module and the service bundle is an object that can use the program module. The information on the bundle is stored in a service descriptor (“build.xml”) S39 with an XML file format. Unlike the existing bundle of the OSGi, the bundle according to the present invention has no bundle activator. Instead, the service bundle activator S32 of the service manager is used. Therefore, when the bundle is registered in the OSGi framework, the bundle activator parses “bundle.xml”, generates the service bundle info S36, and registers it in the service registry S36 of the OSGi framework.

Every when the service bundle is requested, the service installer S34 finds the information on the corresponding bundle S38 from the bundle repository and generates a service bundle. The service bundle info is an object that manages the information for allows another bundle of the OSGi framework to use the service bundle. The service installer installs the service bundle in the bundle cache S40, and finds a reference of the service bundle info object of the bundle newly started in the service registry every when a specific event of “BUNDLE STARTED” is received. Then, using the service bundle info object, the service installer generates the service bundle object S31.

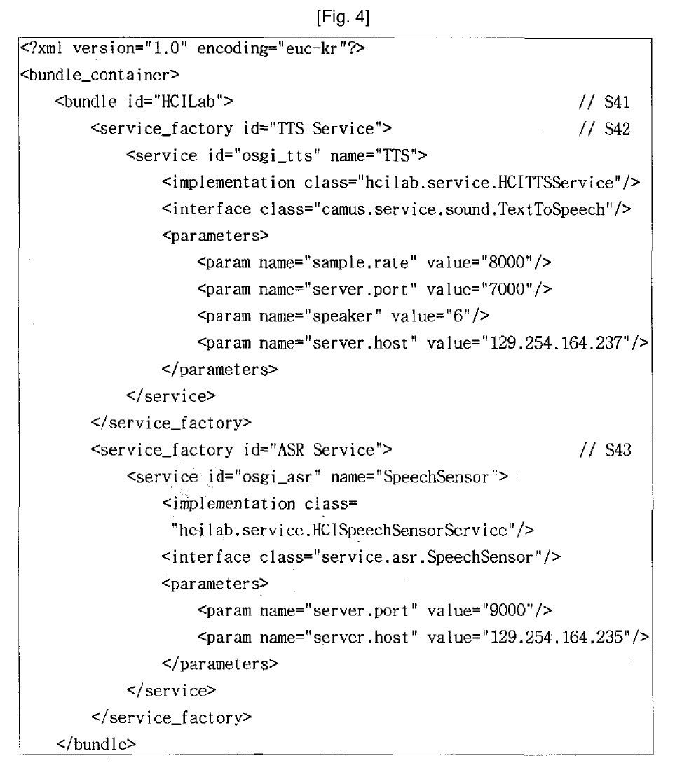

The service bundle has several service implementations, and the service factory object is generated as many as the service implementations and manages the lifecycle of the service. The service factory object provides a function for generating and uninstalling the service. For example, when the user requests the generation of the service by assigning a parameter, which is necessary to generate a service ID, to the service factory object, the service factory object generates an instant of the service implementation. For example, if the service ID is “bedroom_light” and “10” is assigned to a parameter intensity value, the service factory generates a service of turning on the light of the bedroom in which the intensity of the light is “10”. Also, when the user requests the uninstallation of the specific service to the service factory object, the service factory object terminates the service. An internal state of the service factory object is permanently managed in an XML text format. Every when the service is generated or uninstalled, the related information is obtained from an XML file of “bundle_descriptor.xml”. An example of the service descriptor (“build.xml”) is illustrated in FIG. 4. The service factory has an interface API that can start and stop the individual services, and the respective services are managed by the identifiers.

Service Descriptor for Service Bundle

FIG. 4 illustrates an example of the service descriptor containing the information on the service bundle. If the bundle is stored in an XML format, it has a name of “bundle.xml”. The bundle S41 having one identifier “HCILab” is configured with two service implementations having a TTSService identifier S42 and an ASRService identifier S43. The bundle activator described in FIG. 3 parses this file to generate the service bundle info object and registers it the service registry. Using the service bundle info object, the service installer generates the service bundle object.

Procedures of Dynamic Service Management

FIG. 5A to 5D are diagrams illustrating procedures of the service management using the service manager for the dynamic service method according to the present invention. The service management includes a bundle registration, a service bundle installation, a service bundle update, and a service bundle uninstallation.

The service bundle is performed by the bundle activator. The bundle activator parses “bundle.xml” (S51), generates the service bundle info, and registers the bundle in the service registry of the OSGi framework (S52).

The service bundle installation is performed by the service installer object. The service installer object refers to the position (URL) of the bundle specified by the user (S53), downloads the corresponding bundle from the repository, and installs it in a local bundle cache (S54). After the bundle is installed in the bundle cache, the service installer receives an event message of “BUNDLE STARTED” (S55). Then, a reference for the service bundle info object of the installed bundle is obtained (S56). The service bundle object is generated from the service bundle info (S57), and the service bundle generates the service factory object for the respective service implementations (S58).

When the user requests the update of the service bundle object (S59), the service bundle object requests the service installer to allow the service bundle to update all bundles existing in the local bundle cache (S60). The service installer examines whether a new version of a bundle exists in the bundle repository (S61). If the new version of the bundle exists, the OSGi framework downloads the new version of the bundle and replaces the bundle of the local bundle cache with the new version of the bundle (S62).

In addition to the update function, the service bundle object also provides a function of uninstalling the bundle of the local bundle cache. As described above with reference to FIG. 4, there exists a link representing the dependency in the service bundle object, the service factory object, and the services. That is, the services are dependent on the service factory object, and the service factory object itself is dependent on the service bundle object. Therefore, if the user requests the installation of the service bundle object itself (S63), all the corresponding service factory objects are uninstalled (S64) and all the service objects belonging to the service factory object are uninstalled. After all the related objects are uninstalled, the uninstallation of the bundle of the local cache in the OSGi framework is requested to the service installer (S65). Finally, the service bundle is uninstalled.

1. An OSGi-based dynamic service management method for context-aware system, characterized in that a service manager comprising a service bundle, a service bundle activator, a service installer, and a service factory is added to an OSGi service framework so as to allow a dynamic service management in the context-aware system, whereby management is achieved in service unit in a bundle, and an object of the service manager is implemented as a remote object so as to remotely manage the object of the service manager, whereby a remote access is possible and various environment modeling is possible.

2. The OSGi-based dynamic service management method of claim 1, wherein the service bundle activator parses a file constructed with two service implementations having TTSService and ASRService identifiers, generates a service bundle info object, and registers the generated service bundle info object in a service registry, and the service installer generates a service bundle object by using the service bundle info, such that the service bundle object is provided in a bundle descriptor.

3. The OSGi-based dynamic service management method of claim 1, wherein individual services are installed within a corresponding bundle according to a request of a remote user with respect to the object of the service installer.

4. The OSGi-based dynamic service management method of claim 1, wherein a service update and uninstall operation and an interface are provided to the user, such that a single service module is updated by the service bundle and a service is uninstalled.
